(19) United States
(12) Patent Application Publication
(10) Pub. No.: US 2018/0290179 A1
(43) Pub. Date: Oct. 11, 2018

(54) PRESSURE WASHER AND METHOD FOR IDENTIFYING SPRAY BAR THEREOF

(71) Applicant: Positec Power Tools (Suzhou) CO., Ltd., Suzhou (CN)

(72) Inventors: Yong Qiao, Suzhou (CN); Pinghua Wu, Suzhou (CN); Yunhong Sun, Suzhou (CN); Wenjin Huang, Suzhou (CN)

(21) Appl. No.: 15/566,478

(22) PCT Filed: Dec. 28, 2016
(86) PCT No.: PCT/CN2016/112676

§ 371 Date: Oct. 13, 2017

(30) Foreign Application Priority Data
Dec. 28, 2015 (CN) 201511003091.5
Nov. 11, 2016 (CN) 201621219325.X

(51) Int. Cl. B08B 3/02; F04B 49/20

(52) U.S. Cl. CPC B08B 3/026; F04B 2203/0209; B08B 2203/027; F04B 49/20

(57) ABSTRACT

A pressure washer and a method for recognizing a spray boom of the pressure washer. The pressure washer includes a housing, including a pump with a motor; a spray boom with a trigger member; and a control part, for recognizing the spray boom connected to the housing, and performing on and off control based on a recognition result or controlling the housing to convey a water flow of a corresponding pressure to the outside based on a recognition result. The pressure washer may be installed with spray booms of different models, so as to expand an applicable range of the pressure washer and improve flexibility of the pressure washer without changing the housing. Moreover, on and off control can be performed according to the recognition result, so as to prevent the housing from being started when no port accessory is mounted.

### BACKGROUND

### Technical Field

The present invention relates to the field of high-pressure cleaning, and in particular, to a pressure washer and a method for recognizing a spray boom thereof.

### Related Art

A washer is a machine capable of flushing surfaces of an object by generating high-pressure water flows. The washer can strip dirt and flush it away, so as to achieve the purpose of cleaning the surfaces of the object. The washer is widely used in all respects of everyday life. As compared with conventional manual washing, a washer reduces the amount of used water, saves time for an operator, and has a relatively desirable cleaning effect.

Therefore, lengths and shapes of gun bodies of washers are different, and required output working conditions of hosts are accordingly different. Therefore, washers equipped with gun bodies having different lengths appear in the market, and users may change gun bodies having different lengths according to different use environments, so as to satisfy output working conditions. However, at present, a user still needs to adjust an output working condition of a pressure washer on the market when changing gun bodies having different lengths of the pressure washer, which brings about inconvenience for the user.

### SUMMARY

On the basis of the above, it is necessary to provide a pressure washer applicable to different environments and a method for recognizing a spray boom thereof with respect to the fact that a user needs to adjust an output working condition of a pressure washer when changing different spray booms for same.

A pressure washer, comprising: a housing, comprising a pump used for conveying a water flow to the outside and a motor used for driving the pump to work; a spray boom, wherein the water flow sprays out from the spray boom; and a control part, disposed in the housing, and used for recognizing a type of the spray boom, and controlling, according to the type of the spray boom, the pump to convey a water flow of a corresponding pressure to the outside.

In the pressure washer, a control part can recognize different spray booms to change the pressure of an output water flow, so as to enable the pressure of the output water flow to match a type of the spray boom, thereby expanding an applicable range of the pressure washer and improving flexibility of the pressure washer.

In an embodiment of the present invention, wherein the control part comprises a recognition module and a rotation rate control module, wherein the recognition module is used for recognizing the type of the spray boom and sending a signal to the rotation rate control module according to the recognition result; and the rotation rate control module controls a rotation rate of the motor according to the recognition result, so that the magnitude of an output water pressure of the pump is corresponding to the type of the spray boom.

In an embodiment of the present invention, wherein a trigger member is optionally disposed on the spray boom, and the recognition module recognizes the trigger member so as to recognize the type of the spray boom.

In an embodiment of the present invention, wherein the trigger member is a magnet or an induction coil, and the recognition module is a hall detection element used for detecting a magnetic field intensity of the magnet or the induction coil.

In an embodiment of the present invention, wherein the trigger member comprises an ejection pin, the recognition module comprises a contact member, and when the spray boom is mounted on the housing, the ejection pin is capable of coming into contact with the contact member so as to trigger the recognition module to send a signal.

In an embodiment of the present invention, wherein the spray boom comprises a high-pressure spray boom and a low-pressure spray boom that are capable of being mounted on the housing alternatively, the length of the high-pressure spray boom is greater than the length of the low-pressure spray boom, a first high-pressure trigger member is disposed on the high-pressure spray boom, no trigger member is disposed on the low-pressure spray boom, the recognition module is capable of recognizing the first high-pressure trigger member and sending a corresponding first signal to the rotation rate control module, and the rotation rate control module adjusts the rotation rate of the motor according to the first signal, so that the pump outputs a first output water pressure; and when recognition module sends a corresponding second signal to the rotation rate control module when detecting no trigger member, and the rotation rate control module adjusts the rotation rate of the motor according to the second signal, so that the pump outputs a second output water pressure, wherein the first output water pressure is greater than the second output water pressure.

In an embodiment of the present invention, wherein information about the spray boom comprises the length of the spray boom, the spray boom comprises a high-pressure spray boom and a low-pressure spray boom that are capable of being mounted on the housing alternatively, the length of the high-pressure spray boom is greater than the length of the low-pressure spray boom, a first high-pressure trigger member is disposed on the high-pressure spray boom, a first low-pressure trigger member is disposed on the low-pressure spray boom, the recognition module is capable of recognizing the first high-pressure trigger member and sending a corresponding first signal to the rotation rate control module, and the rotation rate control module adjusts the rotation rate of the motor according to the first signal, so that the pump outputs a first output water pressure; and the recognition module is further capable of recognizing the first low-pressure trigger member and sending a corresponding second signal to the rotation rate control module, and the rotation rate control module adjusts the rotation rate of the motor according to the second signal, so that the pump outputs a second output water pressure, wherein the first output water pressure is greater than the second output water pressure.

In an embodiment of the present invention, wherein the spray boom is retractable, the spray boom in a stretch state corresponds to the high-pressure spray boom, and the spray boom in a retraction state corresponds to the low-pressure spray boom.

In an embodiment of the present invention, wherein the retractable spray boom comprises a first nozzle and a second nozzle, the inner diameter of the first nozzle is greater than the outer diameter of the second nozzle, and the second nozzle is retractably sleeved into the first nozzle.

In an embodiment of the present invention, wherein when the recognition module does not detect the trigger member, the rotation rate control module controls the pump to be in an off state, and the output water pressure of the pump is 0.

In an embodiment of the present invention, wherein the housing further comprises a control switch, and the control switch is electrically connected to one end of the motor, so as to control the working state of the motor.

In an embodiment of the present invention, wherein the housing further comprises a switch unit connected between the rotation rate control module and the motor, the recognition module sends a switch-on forbidding signal to the rotation rate control module when not detecting the trigger member, and the rotation rate control module controls the switch unit according to the switch-on forbidding signal, so that the motor losses power, and the control switch is incapable of starting the pressure washer.

In an embodiment of the present invention, wherein the switch unit comprises a field effect transistor, and the rotation rate control module controls on and off of the field effect transistor according to the switch-on forbidding signal.

In an embodiment of the present invention, wherein the switch unit further comprises a driver module connected between the field effect transistor and the rotation rate control module, and the control module turns on or turns off the field effect transistor by means of the driver module.

In an embodiment of the present invention, wherein the form of the housing is set to a hand-held gun type.

The present invention also provides a method of recognizing a spray boom of a pressure washer, a method for recognizing a spray boom of a pressure washer, comprising the following steps: recognizing a spray boom; sending a corresponding signal according to a recognition result; and receiving the signal and controlling, according to the signal, conveying of a water flow of a corresponding pressure to the outside.

In an embodiment of the present invention, wherein the method for recognizing a spray boom of a pressure washer further comprises the following steps: when the spray boom is not detected, sending a switch-on forbidding signal representing that the spray boom is not detected.

The present invention also provides a pressure washer : a pressure washer, comprising: a housing, comprising a pump used for conveying a water flow to the outside and a motor used for driving the pump to work; a port accessory, mounted onto the housing; and a control part, disposed in the housing, wherein the control part is capable of recognizing different port accessories and change, based on a recognition result, the pressure of a water flow that is conveyed to the outside.

In an embodiment of the present invention, wherein a trigger member is disposed on the port accessory.

In an embodiment of the present invention, wherein the control part comprises a recognition module and a rotation rate control module, and the recognition module is used for recognizing the trigger member and sending a signal to the rotation rate control module according to the recognition result; and the rotation rate control module is used for controlling, according to the signal, the pump to convey a water flow of a corresponding pressure to the outside.

In an embodiment of the present invention, wherein the trigger member is a magnet or an induction coil, and the recognition module is a hall detection element used for detecting a magnetic field intensity of the magnet or the induction coil.

In an embodiment of the present invention, wherein the trigger member comprises an ejection pin, the recognition module comprises a contact member, and when the port accessory is mounted on the housing, the ejection pin is capable of coming into contact with the contact member so as to trigger the recognition module to send a signal.

In an embodiment of the present invention, wherein the port accessory comprises a high-pressure port accessory and a low-pressure port accessory that are capable of being mounted on the housing alternatively, the length of the high-pressure port accessory is greater than the length of the low-pressure port accessory, a first high-pressure trigger member is disposed on the high-pressure port accessory, a first low-pressure trigger member is disposed on the low-pressure port accessory, the recognition module is capable of recognizing the first high-pressure trigger member and sending a corresponding first signal to the rotation rate control module, and the rotation rate control module adjusts the pump according to the first signal, to output a first output water pressure; and the recognition module is further capable of recognizing the first low-pressure trigger member and sending a corresponding second signal to the rotation rate control module, and the rotation rate control module adjusts the pump according to the second signal, to output a second output water pressure, wherein the first output water pressure is greater than the second output water pressure.

In an embodiment of the present invention, wherein the rotation rate control module adjusts a rotation rate of the motor according to the signal sent by the recognition module, so as to adjust an output water pressure of the pump.

In an embodiment of the present invention, wherein the port accessory is detachably mounted onto the housing.

In an embodiment of the present invention, the recognition module is used for recognizing the trigger member so as to recognize the port accessory, and sending a corresponding signal to the rotation rate control module according to information about the port accessory, so as to correspondingly control the pump; when the recognition module does not recognize the port accessory, the rotation rate control module controls the pump to be in an off state, and an output water pressure of the pump is 0; when the recognition module recognizes the port accessory, the rotation rate control module controls the magnitude of an output water pressure of the pump to be corresponding to the information about the port accessory.

In an embodiment of the present invention, the housing further includes a switch unit that is connected between the rotation rate control module and the motor; when the recognition module does not recognize a trigger member, the recognition module sends a switch-on forbidding signal to the rotation rate control module; the rotation rate control module controls the switch unit according to the switch-on forbidding signal, so that the motor losses power and the control switch cannot start the host.

In an embodiment of the present invention, the switch unit includes a field effect transistor; the rotation rate control module performs on and off control on the field effect transistor according to the switch-on forbidding signal.

In an embodiment of the present invention, the switch unit further includes a driver module that is connected between the field effect transistor and the rotation rate control module; the control module turns on or turns off the field effect transistor by means of the driver module.

### BRIEF DESCRIPTION OF THE DRAWINGS

FIG. 1 is a schematic structural diagram of a pressure washer according to an implementation manner;

FIG. 2 is a block diagram of the pressure washer shown in FIG. 1;

FIG. 3 is a front view of a pressure washer according to another implementation manner;

FIG. 4 is a corresponding section view of the pressure washer shown in FIG. 3;

FIG. 5 is a flow chart of a method for recognizing a spray boom of a pressure washer according to an implementation manner; and

FIG. 6 is a schematic diagram of a pressure washer according to another implementation manner.

### DETAILED DESCRIPTION

In order to make it more convenient to understand the present invention, the following describes the present invention more thoroughly with reference to related accompanying drawings. The accompanying drawings show preferred embodiments of the present invention. However, the present invention can be implemented in many different forms, but not limited to the embodiments described in the specification. On the contrary, the purpose of providing the embodiments is to make the understanding of the disclosure of the present invention more thorough and comprehensive.

It should be noted that when an element is recited to be “fixed to” another element, the element may be directly on the another element or may also be in the another element. When an element is considered to be “connected to” another element, the element may be directly connected to the another element or meanwhile may also be in the another element. The terms “vertical”, “horizontal”, “left”, “right”, and the like used in the specification are used only for describing.

Unless otherwise particularly specified, the meanings of all the technical and scientific terms used in the specification are the same as those generally interpreted by persons skilled in the art of the present invention. The terms of the specification in the description of the present invention are used only to describe specific embodiments, but not to limit the present invention. The term “and/or” used in the specification includes any or all combinations of one or more related listed items.

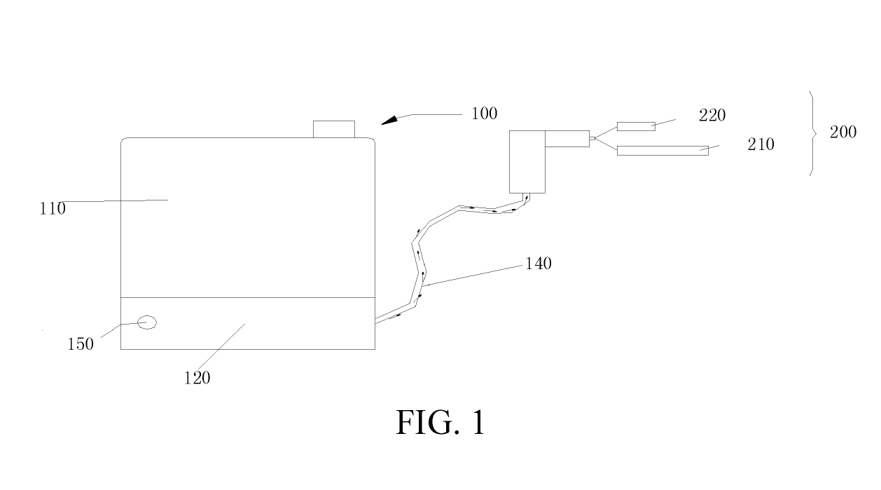

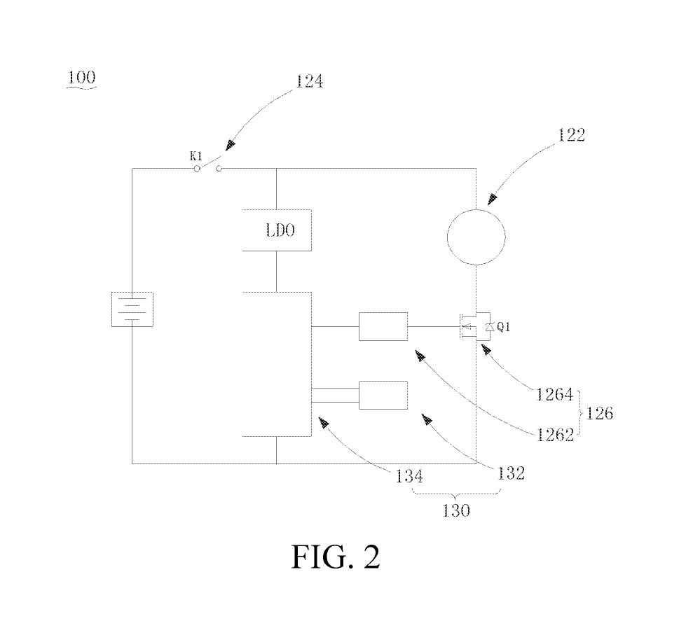

As shown in FIG. 1 and FIG. 2, a pressure washer 100 of a preferred embodiment includes a housing 120, a control part 130, and a port accessory 200 that is detachably mounted onto the housing 120. The port accessory 200 may also be referred to as a spray boom.

Specifically, the housing 120 includes a pump used for conveying a water flow to the outside and a motor 122 used for driving the pump to work. A trigger member is optionally disposed on the port accessory 200. The control part 130 is used for recognizing the trigger member so as to recognize the port accessory 200 connected to the housing 120, and performing on and off control based on a recognition result, or controlling, based on a recognition result, the housing 120 to convey a water flow of a corresponding pressure to the outside.

In the pressure washer 100, the control part 130 can recognize different port accessories 200 according to trigger members on the different port accessories 200. Therefore, the washer 100 can automatically recognize a model of the port accessory 200 so as to change the pressure of the output water flow. Thus, port accessories 200 of different models can be mounted to expand an applicable range of the pressure washer 100 and improve flexibility of the pressure washer 100 without changing the housing 120. Moreover, on and off control can be further performed according to the recognition result, so as to prevent the housing 120 from being started when no port accessory 200 is mounted onto the housing.

Still referring to FIG. 1 and FIG. 2, the pressure washer 100 further includes a water tank 110 and a connection pipe 140. The water tank 110 is used for storing water and is connected to the housing 120. The motor 122 in the housing 120 drives the pump to work to further enable the housing 120 to convey a water flow to the outside. The port accessory 200 is connected to a water outlet of the housing 120 by means of the connection pipe 140. The water in the water tank 110 flows via the connection pipe 140 and out of the port accessory 200 under the drive of the motor 122 in the housing 120. The control part 130 can recognize the port accessory 200 and control, based on a recognition result, the housing 120 to convey a water flow of a corresponding pressure such as a high-pressure water flow or a low-pressure water flow to the outside.

In another embodiment, the water tank 110 in the pressure washer 100 may be omitted according to an actual use situation, and a water inlet of the housing 120 is directly jointed to a water outlet of a water source (for example, tap water). Alternatively, according to requirements of a use environment, the connection pipe 140 may be omitted, and the housing 120 is directly jointed to the port accessory 200, to control the pressure washer 100 to output a high-pressure water flow or a low-pressure water flow.

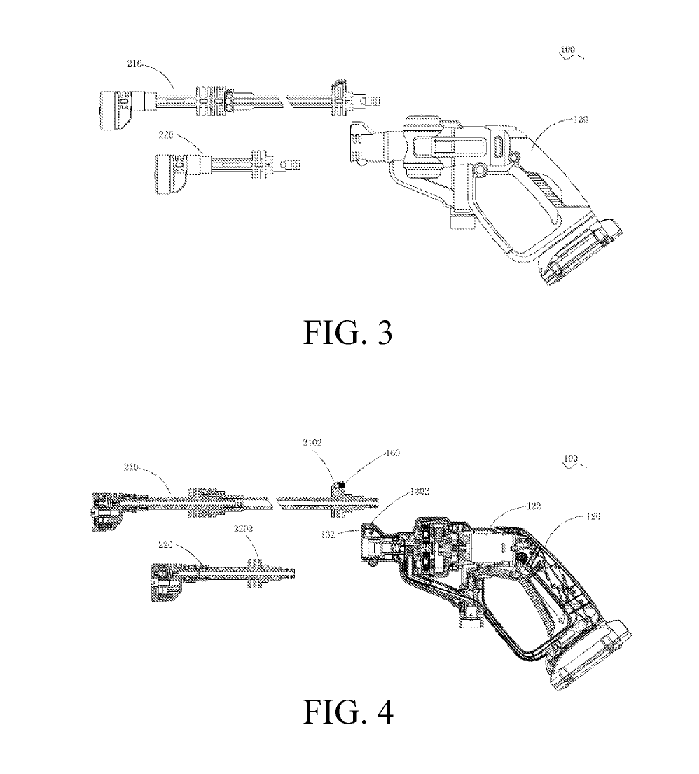

In another embodiment, the housing 120 of the pressure washer 100 may be presented in other forms. FIG. 3 and FIG. 4 show a hand-held pressure washer 100. In the embodiment, a housing 120 is set to a gun type, and a motor 122, a pump, and a control part 130 are all arranged in the gun body of the housing 120.

Specifically, the control part 130 includes a recognition module 132 and a rotation rate control module 134. The recognition module 132 is used for recognizing a trigger member and sending a signal to the rotation rate control module 134 according to a recognition result. The rotation rate control module 134 performs on and off control according to the signal or controls, according to the signal, the housing 120 to convey a water flow of a corresponding pressure to the outside.

In this embodiment, the recognition module 132 is used for recognizing a trigger member so as to recognize a port accessory 200, and sending a corresponding signal to the rotation rate control module 134 according to information about the port accessory 200, so as to correspondingly control the pump. When the recognition module 132 does not recognize the port accessory 200, the rotation rate control module 134 controls the pump to be in an off state, and an output water pressure of the pump is 0. When the recognition module 132 recognizes a port accessory 200, the rotation rate control module 134 controls the magnitude of an output water pressure of the pump to be corresponding to the information about the port accessory 200.

Further, the pressure washer 100 includes two or more port accessories 200. A trigger member is disposed on each of the two or more port accessories 200. The recognition module 132 can recognize trigger members of different port accessories 200 and send, according to the trigger members, corresponding signals to the rotation rate control module 134.

Specifically, the port accessories 200 include a high-pressure port accessory 210 and a low-pressure port accessory 220 that are capable of being mounted on the housing 120 alternatively. Generally, in order to meet the security specification requirements in the industry, the high-pressure port accessory 210 corresponds to a long nozzle structure, the low-pressure port accessory 220 corresponds to a short nozzle structure, and the length of the high-pressure port accessory 210 is greater than that of the low-pressure port accessory 220. A first high-pressure trigger member (not shown) is disposed on the high-pressure port accessory 210, and a first low-pressure trigger member (not shown) is disposed on the low-pressure port accessory 220. The recognition module 132 can recognize the first high-pressure trigger member and send a corresponding first signal to the rotation rate control module 134. The rotation rate control module 134 adjusts the housing 120 according to the first signal, to output a first output water pressure, and controls the motor 122 to keep rotating at a high speed, so as to enable the pressure washer 100 to convey a high-pressure water flow to the outside. The recognition module 132 can further recognize the first low-pressure trigger member and send a corresponding second signal to the rotation rate control module 134. The rotation rate control module 134 adjusts the pump of the housing 120 according to the second signal, to output a second output water pressure, and controls the motor 122 to keep rotating at a low speed, so as to enable the pressure washer 100 to convey a low-pressure water flow to the outside. Therefore, the first output water pressure is greater than the second output water pressure, thereby satisfying different requirements of the high-pressure port accessory 210 and the low-pressure port accessory 220.

More specifically, when the recognition module 132 detects the first high-pressure trigger member, the recognition module 132 sends a first signal to the rotation rate control module 134, and the rotation rate control module 134 can start the motor 122 according to the first signal and control the rotation rate of the motor 122, to enable the output water pressure of the pump to be relatively great. When the recognition module 132 detects the first low-pressure trigger member, the recognition module 132 sends a second signal to the rotation rate control module 134, and the rotation rate control module 134 can start the motor 122 according to the second signal and control the rotation rate of the motor 122, to enable the output water pressure of the pump to be relatively small.

Therefore, when a user needs the pressure washer 100 to convey a high-pressure water flow to the outside, the user connects a corresponding high-pressure port accessory 210 having a long nozzle structure to a water outlet of the pressure washer 100, to enable a first high-pressure trigger member of the high-pressure port accessory 210 to come into contact with the recognition module 132. The recognition module 132 controls, based on a recognition result, the motor 122 to keep rotating at a high speed, to enable the pressure washer 100 to convey a high-pressure water flow to the outside. When a user needs the pressure washer 100 to convey a low-pressure water flow to the outside, the user replaces the high-pressure port accessory 210 with a low-pressure port accessory 220 having a short nozzle structure, and the recognition module 132 recognizes that a connected spray boom is the low-pressure port accessory 220 and controls, based on the recognition result, the motor 122 to keep rotating at a low speed, to further enable the pressure washer 100 to convey a low-pressure water flow to the outside.

In another embodiment, the control part 130 includes a first recognition module (not shown) and a second recognition module (not shown). When the high-pressure port accessory 210 is connected to the water outlet of the housing 120, the first high-pressure trigger member of the high-pressure port accessory 210 comes into contact with the corresponding first recognition module, and the first recognition module recognizes that the connected spray boom is the high-pressure port accessory 210 and controls the motor 122 to keep rotating at a high speed, to further enable the pressure washer 100 to convey a high-pressure water flow to the outside. When the low-pressure port accessory 220 is connected to the water outlet of the housing 120, the first low-pressure trigger member of the low-pressure port accessory 220 comes into contact with the second recognition module, and the second recognition module recognizes that the connected spray boom is the low-pressure port accessory 220 and controls the motor 122 to keep rotating at a low speed, to further enable the pressure washer 100 to convey a low-pressure water flow to the outside.

Therefore, when a user needs the pressure washer 100 to convey a high-pressure water flow to the outside, the user connects a corresponding high-pressure port accessory 210 having a long nozzle structure to a water outlet of the pressure washer 100, to enable a first high-pressure trigger member of the high-pressure port accessory 210 to come into contact with the first recognition module. At this time, the first recognition module recognizes that the connected accessory is the high-pressure port accessory 210, the second recognition module is in an idle state, and the first recognition module controls, based on the recognition result, the motor 122 to keep rotating at a high speed, to enable the pressure washer 100 to convey a high-pressure water flow to the outside. When a user needs the pressure washer 100 to convey a low-pressure water flow to the outside, the user replaces the high-pressure port accessory 210 with a low-pressure port accessory 220 having a short nozzle structure. At this time, the first recognition module is in an idle state, and the first low-pressure trigger member of the low-pressure port accessory 220 comes into contact with the corresponding second recognition module. In this case, the second recognition module recognizes that the connected spray boom is a low-pressure port accessory 220 and controls, based on the recognition result, the motor 122 to keep rotating at a low speed, to further enable the pressure washer 100 to convey a low-pressure water flow to the outside. In this way, the pressure washer 100 can satisfy the situation in which a user needs the pressure washer 100 to convey a high-pressure water flow to the outside, and meanwhile meet security specification about pressure washers 100 in this industry.

In another embodiment, the port accessory 200 may also include a multi-pressure accessory. The multi-pressure accessory has a low-pressure state with a relatively short port and a high-pressure state with a relatively long port. In accordance with the states, the multi-pressure accessory has a second high-pressure trigger member and a second low-pressure trigger member. When the pressure washer 100 needs to operate at a low pressure, the spray boom is switched to the low-pressure state with a relatively short port. At this time, the second low-pressure trigger member comes into contact with the recognition module 132, and the recognition module 132 recognizes that the connected multi-pressure accessory is in the low-pressure state and controls, based on a recognition result, the motor 122 to keep rotating at a low speed, to further enable the pressure washer 100 to convey a low-pressure water flow to the outside. When the pressure washer 100 needs to be operated at a high pressure, the port accessory 200 is switched to the high-pressure state with a relatively long port. The second high-pressure trigger member is enabled to come into contact with the recognition module 132. At this time, multi-pressure accessory connected to the recognition module 132 is in the high-pressure state, and controls, based on the recognition result, the motor 122 to keep rotating at a high speed, to further enable the pressure washer 100 to convey a high-pressure water flow to the outside. Another principle is similar to the above, and is not described in detail herein.

More specifically, a converter is disposed on the pressure washer 100. The converter is connected to the rotation rate control module 134. The rotation rate control module 134 can change frequency of a power source by controlling the converter, so as to change the rotation rate of the driving motor 122. It should be understood that methods for changing the rotation rate of the driving motor 122 are not limited herein, and can be set according to actual needs.

A control switch 124 is further disposed on the housing 120, and by means of the control switch 124, an operator can control a working condition of the housing 120. Specifically, the control switch 124 is electrically connected to one end of the motor 122, so as to control the working state of the motor 122. When the operator operates the control switch 124 to be closed, the motor 122 is powered and works, and when the operator switches off the control switch 124, the motor 122 losses power and stops working. In this way, the operator can operate the control switch 124 so as to control the working condition of the pressure washer 100.

In this embodiment, the housing 120 further includes a switch unit 126. The switch unit 126 is connected between the rotation rate control module 134 and the motor 122. The rotation rate control module 134 controls the switch unit 126 to co-work with the control switch 124, so as to control a working condition of the motor 122. When the recognition module 132 does not recognize a trigger member, the recognition module 132 sends a switch-on forbidding signal to the rotation rate control module 134. The rotation rate control module 134 switches off the switch unit 126 according to the switch-on forbidding signal, so that the motor 122 losses power and cannot be started, thereby avoiding start of the housing 120 caused by misoperation when no port accessory 200 is connected to the housing 120. When the recognition module 132 recognizes a trigger member, the recognition module 132 sends a signal to the rotation rate control module 134. The rotation rate control module 134 controls the switch unit 126 to be turned on, so that the motor 122 drives, under the control of the control switch 124, the pump to work.

Specifically, the switch unit 126 includes a field effect transistor 1262. In this embodiment, the field effect transistor 1262 is a MOS transistor (metal oxide semiconductor, metal-oxide-semiconductor field effect transistor). The rotation rate control module 134 performs on and off control on the MOS transistor according to the signal and the switch-on forbidding signal. When the rotation rate control module 134 receives the signal, the rotation rate control module 134 outputs a voltage to turn on the MOS transistor, so as to enable the motor 122 to be in an operable state. At this time, the motor 122 can enter a working state when the control switch 124 is closed. When the rotation rate control module 134 receives the switch-on forbidding signal, the MOS transistor is turned off, so that the motor 122 losses power and is not able to work. At this time, even if the control switch 124 is closed, the motor 122 is still in a power-off state.

The switch unit 126 further includes a driver module 1264 connected between the MOS transistor and the rotation rate control module 134. The rotation rate control module 134 turns off or turns on the MOS transistor by means of the driver module 1264, so as to increase the turn-on speed of the MOS transistor, thereby increasing the response speed of the motor 122 and making operation of the pressure washer 100 faster and more convenient.

In this embodiment, the trigger member is a magnet or an induction coil, and the recognition module 132 is a hall detection element. Specifically, the hall detection element may be used for measuring a magnetic field intensity of the magnet or the induction coil, generating a corresponding voltage value according to the magnetic field intensity, and then sending the voltage value as a signal to the rotation rate control module 134. The rotation rate control module 134 adjusts the working condition of the housing 120 according to the obtained signal. In this way, the magnetic field intensity of a first trigger member on the high-pressure port accessory 210 and the magnetic field intensity of a second trigger member on the low-pressure port accessory 220 are different, so that the recognition module 132 generates different voltage values.

Alternatively, a trigger member is disposed on the high-pressure port accessory 210, and no trigger member is dispose don the low-pressure port accessory 220, so that the recognition module 132 generates different voltage values. When the low-pressure port accessory 220 is connected to the housing 120, a voltage value recognized by the recognition module 132 is 0 because no trigger member exists. When the high-pressure port accessory 210 is connected to the housing 120, the recognition module 132 detects the trigger member and generates a corresponding non-zero voltage value because the trigger member exists. In the hand-held pressure washer 100 shown in FIG. 4, the recognition module 132 is disposed in a connection terminal 1202, which is connected to the spray boom, of the housing 120. A trigger member 160 is disposed in a terminal 2102, which is connected to the connection terminal 1202, of the high-pressure port accessory 210. The trigger member 160 is a magnet or an induction coil. No trigger member 160 is disposed in a terminal 2202, which is connected to the connection terminal 1202, of the low-pressure port accessory 220. In another embodiment, the trigger member includes an ejection pin, and the recognition module 132 includes a contact member. When the port accessory 200 is mounted on the housing 120, the ejection pin stretches into the housing 120. An end portion of the ejection pin can come into contact with the contact member in the housing 120, so as to trigger the recognition module 132 to send a signal. The structure of the end portion of the ejection pin of the high-pressure port accessory 210 is different from that of the low-pressure port accessory 220, so that the recognition module 132 sends corresponding signals and the rotation rate control module 134 controls, according to the signals, the housing 120 to output different working conditions.

Further, the pressure washer 100 also includes a relief valve 150, and the relief valve 150 further includes an adjusting element for adjusting relief pressure of the relief valve 150 based on a recognition result of the recognition module 132. When the pressure washer 100 outputs a corresponding high-pressure water flow or low-pressure water flow, the adjusting element controls the relief valve 150, so that predefined maximum pressure values of the corresponding high-pressure water flow or low-pressure water flow of the pressure washer 100 are not exceeded. For example, when the pressure washer 100 outputs a low-pressure water flow, the adjusting element controls the relief valve 150, so that the pressure washer 100 outputs a low-pressure water flow not exceeding 2.2 Mpa. When the pressure washer 100 outputs a high-pressure water flow, the adjusting element controls the relief valve 150, so that the pressure washer 100 outputs a high-pressure water flow not exceeding 4.2 Mpa.

Furthermore, the high-pressure port accessory 210 comes into contact with the recognition module 132 by means of the first high-pressure trigger member. At the same time when the recognition module 132 sends, to the motor 122 based on the recognition result by means of the rotation rate control module 134, a signal for keeping rotating at a high speed, the adjusting element of the relief valve 150 receives the corresponding signal. At this time, the adjusting element controls the relief valve 150 and modifies the relief valve 150 to correspond to the predefined maximum pressure value of the high-pressure water flow, so that the pressure of the water flow output by the pressure washer 100 does not exceed the pressure value predefined for the high pressure, for example, 4.2 Mpa. Then, when the relief valve 150 detects that the pressure of the water flow output by the pressure washer 100 exceeds 4.2 Mpa, the relief valve 150 releases redundant pressure of the water flow output by the pressure washer 100, so that the pressure of the water flow output by the pressure washer 100 remains below 4.2 Mpa. In another aspect, the low-pressure port accessory 220 comes into contact with the recognition module 132 by means of the first low-pressure trigger member. At the same time when the recognition module 132 sends, to the motor 122 based on the recognition result by means of the rotation rate control module 134, a signal for keeping rotating at a low speed, the adjusting element of the relief valve 150 also receives the corresponding signal. At this time, the adjusting element controls the relief valve 150 and modifies the relief valve 150 to correspond to the predefined maximum pressure value of the low-pressure water flow, so that the pressure of the water flow output by the pressure washer 100 does not exceed the pressure value predefined for the low pressure, for example, 2.2 Mpa. Then, when the relief valve 150 detects that the pressure of the water flow output by the pressure washer 100 exceeds 2.2 Mpa, the relief valve 150 releases redundant pressure of the water flow output by the pressure washer 100, so that the pressure of the water flow output by the pressure washer 100 remains below 2.2 Mpa.

It should be understood that the relief valve 150 may be disposed on the housing 120, or may be disposed between the port accessory 200 and the water outlet of the housing 120, which is not defined in the present invention.

In the pressure washer 100, different port accessories 200 may be disposed on the housing 120, and the housing 120 may recognize the different port accessories 200, and output water flows of different pressures according to different port accessories 200, so as to co-work with different port accessories 200, satisfy different use requirements, and expand an applicable range of the pressure washer 100. An operator only needs to change a port accessory 200 according to different use environments, without changing the whole pressure washer 100. In addition, when no port accessory 200 is connected to the housing 100, the housing 100 is in a turn-on forbidding state, so as to prevent the housing 100 from working when no port accessory 200 is connected to the housing 120.

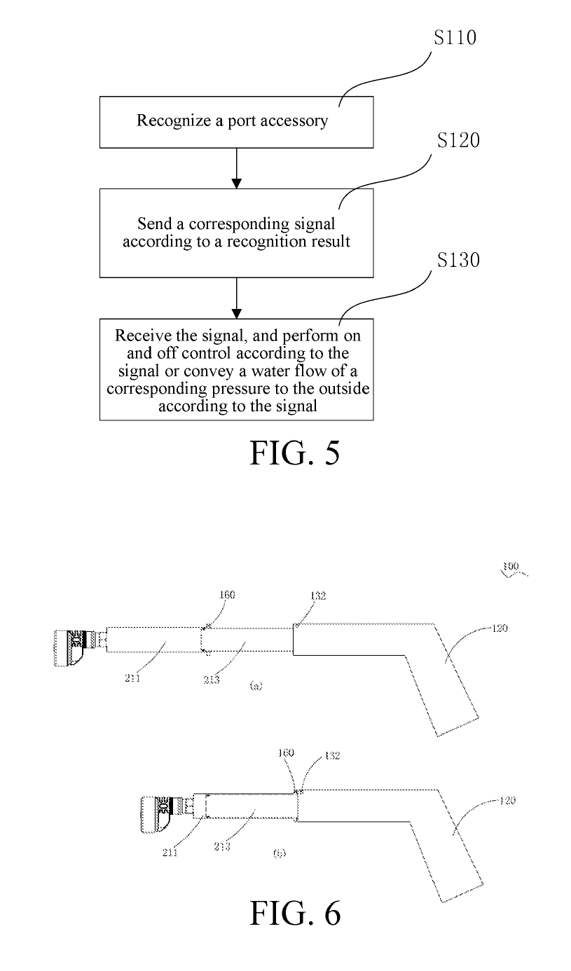

As shown in FIG. 5, a method for recognizing a spray boom of a pressure washer 100 of a preferred embodiment includes the following steps:

S110: Recognize a port accessory 200.

S120: Send a corresponding signal according to a recognition result.

S130: Receive the signal, and perform on and off control according to the signal or convey a water flow of a corresponding pressure to the outside according to the signal.

In the method for recognizing a spray boom of a pressure washer 100, whether a housing 120 is connected to a port accessory 200 and is capable of recognizing different port accessories 200 is determined by detecting a trigger member, to control a working condition of the pressure washer 100 according to whether a port accessory 200 is connected and different models of the port accessories 200, so as to co-work with different port accessories 200 and satisfy different use requirements.

The method for recognizing a spray boom of a pressure washer 100 further includes the following step:

S140: When no port accessory 200 is detected, send a switch-on forbidding signal representing that no trigger member is detected.

Specifically, as shown in FIG. 2 and FIG. 3, when a control part 130 does not detect a trigger member, the control part 130 sends a corresponding switch-on forbidding signal, so that a motor 122 of the housing 120 losses power, so as to prevent the housing 120 from running when no port accessory 200 is connected to the housing 120.

Specifically, in this embodiment, the length of the port accessory 200 is in a positive correlation with an output water pressure generated by the housing 120 according to the signal. A longer length of the port accessory 200 corresponds to a greater output water pressure, so as to satisfy cleaning requirements of the pressure washer 100.

In this way, the control part 130 sends different signals to the rotation rate control module 134 according to spray booms having different lengths, to generate different working conditions, so as to satisfy requirements of different port accessories 200. Moreover, the control part 130 may also send a switch-on forbidding signal to the rotation rate control module 134 when no trigger member is detected, to prevent the housing 120 from being started when no port accessory 200 is connected to the housing 120.

In the method for recognizing a spray boom of a pressure washer 100, a corresponding signal can be output by detecting a trigger member, to further control a working condition of the pressure washer 100. Therefore, different port accessories 200 can be mounted on the housing 120 of the pressure washer 100 alternatively, and the pressure washer 100 can automatically recognize the port accessories 200 and output water flows of corresponding pressures, so as to satisfy requirements of different use environments without changing the whole pressure washer. Moreover, a waste of electricity and generation of security risks caused by start of the housing 120 when no port accessory 200 is connected to the housing 120 can be avoided.

FIG. 6 shows another hand-held pressure washer 100. In this embodiment, the high-pressure port accessory 210 and the low-pressure port accessory 220 can be formed by a retractable spray boom. When the retractable spray boom is in a stretch state, the pressure washer 100 is equivalently connected to the high-pressure port accessory 210. When the retractable spray boom is in a retraction, the pressure washer 100 is equivalently connected to the low-pressure port accessory 220. Specifically, as shown in FIG. 6(a) and FIG. 6(B), the retractable spray boom includes a first nozzle 211 and a second nozzle 213. The inner diameter of the first nozzle 211 is greater than or equal to the outer diameter of the second nozzle 213. The second nozzle 213 and the first nozzle 211 may be movably sleeved to each other. As shown in FIG. 6(a), the second nozzle 213 retractably stretches out of the first nozzle 211, to form a high-pressure port accessory 210. As shown in FIG. 6(b), the second nozzle 213 retractably retracts into the first nozzle 211, to form a low-pressure port accessory 220.

Preferably, in the embodiment, a recognition module 132 is disposed on the housing 120 at a connection with the port accessory. A trigger member 160 is disposed on the first nozzle 211 at a connection with the second nozzle 213. No trigger member is disposed on the second nozzle 213. When the second nozzle 213 in a state of retracting into the first nozzle 211, the recognition module 132 is capable of detecting the trigger member 160, so as to generate a recognition signal. The rotation rate control module 134 controls, according to the recognition signal, a rotation rate of the motor to be within a rotate rate range for a low-pressure state. When the second nozzle 213 is in a state of stretching out of the first nozzle 211, a distance between the trigger member 160 and the recognition module 132 is excessively long, and the recognition module 132 is incapable of detecting the trigger member 160. The rotation rate control module 134 receives no recognition signal and controls the motor to be within a rotation rate range for a high-pressure state.

In the embodiment, the high-pressure port accessory 210 and the low-pressure port accessory 220 are formed by a dual-section type retractable spray boom. In another embodiment, the high-pressure port accessory 210 and the low-pressure port accessory 220 may also be formed by retractable spray boom having more than two sections. In the embodiment, the retractable spray boom may be detachably mounted on the housing 120, or be directly integrated with the housing 120.

The technical features of the embodiments can be randomly combined. For concise description, not all possible combinations of all the technical features in the above embodiments are described. However, no conflict exists between the combinations of the technical features, and all the combinations of the technical features should be considered within the scope of the disclosure of the description.

The above embodiments are only several implementation manners of the present invention, and are described in particular and in detail, but should not be understood as a limit to the scope of the invention patent. It should be noted that several transformations and modifications can be further made by persons of ordinary skill in the art without departing from the concept of the present invention, which all fall within the protection scope of the present invention. Therefore, the protection scope of the present invention patent should be subject to the appended claims.

1. A pressure washer, comprising:
a housing, comprising a pump used for conveying a water flow to the outside and a motor used for driving the pump to work;
a spray boom, wherein the water flow sprays out from the spray boom; and
wherein a control part, disposed in the housing, and used for recognizing a type of the spray boom, and controlling, according to the type of the spray boom, the pump to convey a water flow of a corresponding pressure to the outside.

2. The pressure washer according to claim 1, wherein the control part comprises a recognition module and a rotation rate control module, wherein the recognition module is used for recognizing the type of the spray boom and sending a signal to the rotation rate control module according to the recognition result; and the rotation rate control module controls a rotation rate of the motor according to the recognition result, so that the magnitude of an output water pressure of the pump is corresponding to the type of the spray boom.

3. The pressure washer according to claim 2, wherein a trigger member is optionally disposed on the spray boom, and the recognition module recognizes the trigger member so as to recognize the type of the spray boom.

4. The pressure washer according to claim 3, wherein the trigger member is a magnet or an induction coil, and the recognition module is a hall detection element used for detecting a magnetic field intensity of the magnet or the induction coil.

5. The pressure washer according to claim 3, wherein the trigger member comprises an ejection pin, the recognition module comprises a contact member, and when the spray boom is mounted on the housing, the ejection pin is capable of coming into contact with the contact member so as to trigger the recognition module to send a signal.

6. The pressure washer according to claim 3, wherein the spray boom comprises a high-pressure spray boom and a low-pressure spray boom that are capable of being mounted on the housing alternatively, the length of the high-pressure spray boom is greater than the length of the low-pressure spray boom, a first high-pressure trigger member is disposed on the high-pressure spray boom, no trigger member is disposed on the low-pressure spray boom, the recognition module is capable of recognizing the first high-pressure trigger member and sending a corresponding first signal to the rotation rate control module, and the rotation rate control module adjusts the rotation rate of the motor according to the first signal, so that the pump outputs a first output water pressure; and when recognition module sends a corresponding second signal to the rotation rate control module when detecting no trigger member, and the rotation rate control module adjusts the rotation rate of the motor according to the second signal, so that the pump outputs a second output water pressure, wherein the first output water pressure is greater than the second output water pressure.

7. The pressure washer according to claim 3, wherein information about the spray boom comprises the length of the spray boom, the spray boom comprises a high-pressure spray boom and a low-pressure spray boom that are capable of being mounted on the housing alternatively, the length of the high-pressure spray boom is greater than the length of the low-pressure spray boom, a first high-pressure trigger member is disposed on the high-pressure spray boom, a first low-pressure trigger member is disposed on the low-pressure spray boom, the recognition module is capable of recognizing the first high-pressure trigger member and sending a corresponding first signal to the rotation rate control module, and the rotation rate control module adjusts the rotation rate of the motor according to the first signal, so that the pump outputs a first output water pressure; and the recognition module is further capable of recognizing the first low-pressure trigger member and sending a corresponding second signal to the rotation rate control module, and the rotation rate control module adjusts the rotation rate of the motor according to the second signal, so that the pump outputs a second output water pressure, wherein the first output water pressure is greater than the second output water pressure.

8. The pressure washer according to claim 2, wherein the spray boom is retractable, the spray boom in a stretch state corresponds to the high-pressure spray boom, and the spray boom in a retraction state corresponds to the low-pressure spray boom.

9. The pressure washer according to claim 8, wherein the retractable spray boom comprises a first nozzle and a second nozzle, the inner diameter of the first nozzle is greater than the outer diameter of the second nozzle, and the second nozzle is retractably sleeved into the first nozzle.

10. The pressure washer according to claim 3, wherein when the recognition module does not detect the trigger member, the rotation rate control module controls the pump to be in an off state, and the output water pressure of the pump is 0.

11. The pressure washer according to claim 3, wherein the housing further comprises a control switch, and the control switch is electrically connected to one end of the motor, so as to control the working state of the motor.

12. The pressure washer according to claim 11, wherein the housing further comprises a switch unit connected between the rotation rate control module and the motor, the recognition module sends a switch-on forbidding signal to the rotation rate control module when not detecting the trigger member, and the rotation rate control module controls the switch unit according to the switch-on forbidding signal, so that the motor losses power, and the control switch is incapable of starting the pressure washer.

13. The pressure washer according to claim 12, wherein the switch unit comprises a field effect transistor, and the rotation rate control module controls on and off of the field effect transistor according to the switch-on forbidding signal.

14. The pressure washer according to claim 13, wherein the switch unit further comprises a driver module connected between the field effect transistor and the rotation rate control module, and the control module turns on or turns off the field effect transistor by means of the driver module.

15. The pressure washer according to claim 1, wherein the form of the housing is set to a hand-held gun type.

16. A method for recognizing a spray boom of a pressure washer, comprising the following steps:
recognizing a spray boom;
sending a corresponding signal according to a recognition result; and
receiving the signal and controlling, according to the signal, conveying of a water flow of a corresponding pressure to the outside.

17. The method for recognizing a spray boom according to claim 16, wherein the method for recognizing a spray boom of a pressure washer further comprises the following steps: when the spray boom is not detected, sending a switch-on forbidding signal representing that the spray boom is not detected.

18. A pressure washer, comprising:
a housing, comprising a pump used for conveying a water flow to the outside and a motor used for driving the pump to work;
a port accessory, mounted onto the housing; and
a control part, disposed in the housing, wherein the control part is capable of recognizing different port accessories and change, based on a recognition result, the pressure of a water flow that is conveyed to the outside.

19. The pressure washer according to claim 18, wherein a trigger member is disposed on the port accessory.

20. The pressure washer according to claim 19, wherein the control part comprises a recognition module and a rotation rate control module, and the recognition module is used for recognizing the trigger member and sending a signal to the rotation rate control module according to the recognition result; and the rotation rate control module is used for controlling, according to the signal, the pump to convey a water flow of a corresponding pressure to the outside.

21. The pressure washer according to claim 20, wherein the trigger member is a magnet or an induction coil, and the recognition module is a hall detection element used for detecting a magnetic field intensity of the magnet or the induction coil.

22. The pressure washer according to claim 20, wherein the trigger member comprises an ejection pin, the recognition module comprises a contact member, and when the port accessory is mounted on the housing, the ejection pin is capable of coming into contact with the contact member so as to trigger the recognition module to send a signal.

23. The pressure washer according to claim 20, wherein the port accessory comprises a high-pressure port accessory and a low-pressure port accessory that are capable of being mounted on the housing alternatively, the length of the high-pressure port accessory is greater than the length of the low-pressure port accessory, a first high-pressure trigger member is disposed on the high-pressure port accessory, a first low-pressure trigger member is disposed on the low-pressure port accessory, the recognition module is capable of recognizing the first high-pressure trigger member and sending a corresponding first signal to the rotation rate control module, and the rotation rate control module adjusts the pump according to the first signal, to output a first output water pressure; and the recognition module is further capable of recognizing the first low-pressure trigger member and sending a corresponding second signal to the rotation rate control module, and the rotation rate control module adjusts the pump according to the second signal, to output a second output water pressure, wherein the first output water pressure is greater than the second output water pressure.

24. The pressure washer according to claim 20, wherein the rotation rate control module adjusts a rotation rate of the motor according to the signal sent by the recognition module, so as to adjust an output water pressure of the pump.

25. The pressure washer according to claim 18, wherein the port accessory is detachably mounted onto the housing.
